(19) United States
(12) Patent Application Publication
(10) Pub. No.: US 2011/0233218 A1
(43) Pub. Date: Sep. 29, 2011

(54) HIGH-PRESSURE TANK

(75) Inventor: Chihiro Uchimura, Toyota-shi (JP)

(73) Assignee: TOYOTA JIDOSHA KABUSHIKI KAISHA, Toyota-shi (JP)

(21) Appl. No.: 13/129,774

(22) PCT Filed: Nov. 18, 2008
(86) PCT No.: PCT/JP2008/070925

§ 371 Date: May 17, 2011

(51) Int. Cl. F17C 1/00

(52) U.S. Cl. 220/581

(57) ABSTRACT

An object of the present invention is to provide a high-pressure tank configured so as to suppress accumulation of gas in a space between a valve and a mouthpiece while achieving low cost. To this end, the high-pressure tank according to the present invention includes the mouthpiece and the valve installed on the mouthpiece, and is formed with: a communicating hole that communicatively connects spaces which are formed between the mouthpiece and the valve, and in the valve, respectively, and in which gas having permeated from the tank side may potentially accumulate; and a gas venting hole that connects either of the spaces to the outside of the tank. The communicating hole is preferably provided closer to a center of the tank than to a screw portion of the valve. In addition, preferably a gas venting hole is formed so as to extend from the space formed between the mouthpiece and the valve in a direction that intersects a contact surface between the mouthpiece and the valve.

### BACKGROUND OF THE INVENTION

The present invention relates to a high-pressure tank. More specifically, the present invention relates to an improvement of a structure around a valve in a high-pressure tank filled with hydrogen gas or the like.

A high-pressure tank configured such that a valve assembly (a component including a built-in high pressure valve or the like) is mounted to a mouthpiece provided in an opening of a high-pressure tank main body is used as a high-pressure tank for storing gases such as hydrogen. In addition, for mounting the valve assembly to the mouthpiece, a simple screw structure is widely used in which a male screw portion of the valve assembly is screwed into a female screw portion of the mouthpiece.

Conventionally, as such a high-pressure tank, for example, Patent Document 1 discloses a high-pressure container comprising a mouthpiece and an atmospheric pressure valve, the high-pressure container further including a ventilation hole having one end thereof opened on a surface of a flange portion facing a liner (a surface facing a liner constituting a tank casing among surfaces of the flange portion) of the mouthpiece.

Patent Document 1: Japanese Patent Application Laid-Open No. 11-082887

However, the high-pressure tank having the structure described above is incapable of discharging gas accumulated in gaps such as a gap between the mouthpiece and a seal plug (welch plug) to the outside. On the other hand, while a high-pressure tank configured such that gas accumulating in gaps in the tank can be discharged to the outside of the tank has been proposed, such a high-pressure tank may require considerable cost.

### SUMMARY OF THE INVENTION

In consideration thereof, it is an object of the present invention to provide a high-pressure tank configured so as to suppress accumulation of gas in a space between a valve and a mouthpiece or the like while achieving low cost.

In order to solve the problems described above, the present inventor has performed various evaluations. Rubber seals are widely used at ends on a tank main body-side of a valve to prevent high-pressure gas inside a high-pressure tank from leaking to the outside. In addition, a vent hole of the gas (gas venting hole) is processed to prevent gas having permeated a rubber seal from accumulating inside a device. Furthermore, in this case, in order to avoid penetration (back penetration) of water from the outside of the gas venting hole into the tank, a seal or the like made of a waterproof and moisture-permeable material (for example, GORE-TEX®) having both waterproofing and aeration properties is provided at the gas venting hole. However, such an arrangement requires cost for processing the rubber seal, the gas venting hole, and the like. Furthermore, if pluralities of the gas venting holes and the GORE-TEX® seals are to be incorporated, processing cost and the trouble of assembly increase in proportion. Focusing on such points, through extensive evaluations on a structure capable of suppressing accumulation of gas while achieving low cost, the present inventor has made findings leading to a solution of the problems discussed above.

The high-pressure tank according to the present invention is based on these findings and includes a mouthpiece and a valve installed on the mouthpiece, wherein the high-pressure tank is formed with: a communicating hole that communicatively connects spaces which are formed between the mouthpiece and the valve, and in the valve, respectively, and in which gas having permeated from the tank side may potentially accumulate; and a gas venting hole that connects either of the spaces to the outside of the tank.

With a structure where spaces in which gas having permeated from the tank side may potentially accumulate (for example, a gas accumulation space formed between the mouthpiece and the valve or a gas accumulation space formed in a vicinity of a center of the valve) are mutually independent, members including a gas venting hole for venting gas from such a space and a GORE-TEX® seal provided at an outlet of the gas venting hole are required for each of the spaces. Conversely, with a high-pressure tank configured such that spaces are communicatively connected (bypassed) to each other, since gas accumulating in one space can be discharged from another space to the outside of the tank via the communicating hole, providing at least one gas venting hole and one GORE-TEX® seal becomes sufficient for the plurality of communicatively-connected spaces. Therefore, a part of the gas venting hole and GORE-TEX® seal which had conventionally been required for each of the spaces can now be omitted.

In such a high-pressure tank, preferably a gas venting hole is formed so as to extend from the space formed between the mouthpiece and the valve in a direction that intersects a contact surface between the mouthpiece and the valve. In this case, plane contact enables the sealed contact surface between the mouthpiece and the valve to remain unharmed and the gas accumulating in the space to be discharged by the gas venting hole.

The communicating hole described above is formed, for example, for communicatively connecting the space formed in the valve in order to house wiring with the space formed between the mouthpiece and the valve. In this case, gas accumulating in a space at which a gas venting hole is not formed is discharged via the communicating hole from another space to the outside of the tank.

In addition, preferably the communicating hole is provided closer to a center of the tank than to a screw portion of the valve. Providing the communicating hole while avoiding the screw portion makes processing of the communicating hole easier than a case where the communicating hole is provided at the screw portion.

Furthermore, preferably the communicating hole communicatively connects at least two spaces among three or more spaces in which gas having permeated from the tank side may potentially accumulate. When there are three or more spaces, by communicatively connecting two spaces thereof or, more preferably all of the spaces by the communicating hole, a greater part of the gas venting hole and the GORE-TEX® seal which had previously been required for each of the spaces can now be omitted.

Moreover, preferably the communicating hole linearly extends in a radial direction of the valve. In this case, a length of the communicating hole can be minimized.

Furthermore, a waterproof and moisture-permeable material having both waterproofing and aeration properties is provided at an opening of the gas venting hole to the outside of the tank.

According to the present invention, a structure capable of suppressing accumulation of gas in a space between a valve and a mouthpiece or the like while achieving low cost can be provided.

### BRIEF DESCRIPTION OF THE DRAWINGS

FIG. 1 is a cross-sectional view of a high-pressure tank according to an embodiment of the present invention; and

FIG. 2 is a cross-sectional view showing features of the high-pressure tank.

1 high-pressure tank
11 mouthpiece
50 valve assembly (valve)
51 communicating hole
52 gas venting hole
52a opening
53 screw portion
64 wiring
66 GORE-TEX® seal (waterproof and moisture-permeable material)
70 tubular space (a space in which gas having permeated from a tank side may potentially accumulate)
80 wiring space (a space in which gas having permeated from a tank side may potentially accumulate)

### DETAILED DESCRIPTION OF THE INVENTION

Hereinafter, a configuration of the present invention will be described in detail with reference to examples of embodiments shown in the drawings.

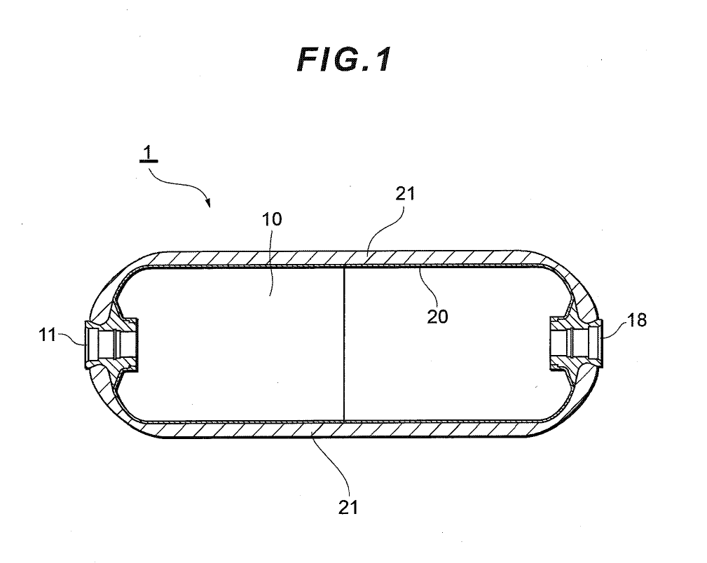

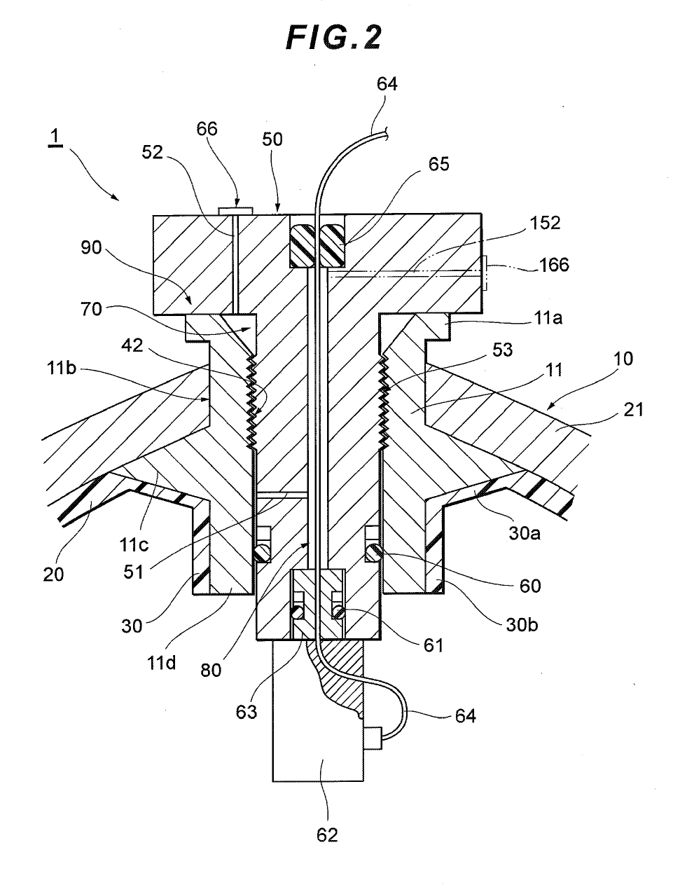

FIGS. 1 and 2 show embodiments of a high-pressure tank 1 according to the present invention. The high-pressure tank 1 is suitable as, for example, a tank for supplying fuel gas in a fuel-cell car. Hereinafter, a case will be described in which the high-pressure tank 1 according to the present invention is applied to a high-pressure hydrogen tank used as a fuel supply source in a fuel cell system (refer to FIG. 1 and the like).

Although particularly not shown, for example, three high-pressure tanks 1 are used mounted on a rear part of a fuel-cell vehicle. The high-pressure tank 1 constitutes a part of the fuel cell system and supplies fuel gas to a fuel cell through a fuel gas piping system. For example, while hydrogen gas is the fuel gas filled in the high-pressure tank 1, the high-pressure tank 1 may alternatively be filled with a combustible high-pressure gas such as compressed natural gas. The high-pressure tank 1 according to the present embodiment is configured so that hydrogen gas can be filled at a pressure of, for example, 35 MPa. Although not particularly shown, when a main stop valve of the high-pressure tank 1 is opened, hydrogen gas flows into a supply channel. Subsequently, flow rate and pressure of the hydrogen gas are regulated by an injector. The pressure of the hydrogen gas is eventually reduced further downstream to around 200 kPa or the like by a pressure reducing valve such as a mechanical regulator, and then supplied to the fuel cell.

FIG. 1 shows a schematic configuration of the high-pressure tank 1. The high-pressure tank 1 comprises a cylindrical tank main body 10 whose both ends have, for example, an approximately hemispherical shape, and mouthpiece portions 11 and 18 respectively mounted to longitudinal ends of the tank main body 10. For example, the tank main body 10 has a two-layer structure wall layer comprising a resin liner 20 that is an inner wall layer and a CFRP layer 21 that is a plastic fiber layer (reinforcement layer) constituting an outer wall layer outside of the resin liner 20. The resin liner 20 that is formed in approximately the same shape as the tank main body 10 is formed of, for example, a hard resin such as polyethylene resin or polypropylene resin. In the present embodiment, the cylindrical resin liner 20 whose both ends have an approximately hemispherical shape is obtained by molding, in advance, two types of split resin liners having shapes created if the resin liner 20 is split approximately at a center of an axial direction of the tank, and subsequently welding the split parts.

A valve assembly 50 controls supply and discharge of fuel gas between an outside gas supply line (supply channel 22) and the inside of the high-pressure tank 1. Seal members 60 and 61 are interposed between an outer circumferential surface of the valve assembly 50 and an inner circumferential surface of the mouthpiece portion 11.

A folded portion 30 bent inward is formed on a distal end side of the resin liner 20 where the mouthpiece 11 is provided (refer to FIG. 2). The folded portion 30 is folded toward the inside of the high-pressure tank main body 10 so as to separate from the outer CFRP layer 21. For example, the folded portion 30 comprises a diameter-reduced portion 30a whose diameter gradually decreases the closer to a distal end of the fold, and a cylindrical portion 30b which is connected to a distal end of the diameter-reduced portion 30a and whose diameter is constant. The cylindrical portion 30b forms an opening of the resin liner 20.

The mouthpiece 11 has an approximately cylindrical shape and is fitted into the opening of the resin liner 20. For example, the mouthpiece 11 is made of aluminum or an aluminum alloy and manufactured into a predetermined shape by die casting or the like, and is mounted to the resin liner 20 by insert molding. A female screw portion 42 for screwing and connecting the valve assembly 50 is formed on an inner circumferential surface of the mouthpiece 11.

The valve assembly 50 controls supply and discharge of fuel gas between an outside gas supply line (the supply channel 22) and the inside of the high-pressure tank 1. A screw portion 53 that screws into the female screw portion 42 of the mouthpiece 11 is formed on an axial part of the valve assembly 50. In order to illustrate a tubular space 70 to be described later in an easily understood manner, FIG. 2 shows the screw portion 53 not meshed with the female screw portion 42, which is a state that differs from an actual state. In addition, the seal members 60 and 61 are interposed between the outer circumferential surface of the valve assembly 50 and the inner circumferential surface of the mouthpiece portion 11.

Furthermore, for example, a flange portion 11a is formed on a distal end-side (outside in an axial direction of the high-pressure tank 1) of the mouthpiece 11, and a depressed portion 11b is formed on a rearward side (inside in the axial direction of the high-pressure tank 1) of the flange portion 11a (refer to FIG. 2). A vicinity of a distal end of the CFRP layer 21 is in contact with the depressed portion 11b in an airtight manner. In addition, a solid lubrication coating such as fluorinated resin is applied to a surface of the depressed portion 11b that is in contact with the CFRP layer 21. Accordingly, a coefficient of friction between the CFRP layer 21 and the depressed portion 11b is reduced.

For example, a further rearward side of the depressed portion 11b of the mouthpiece 11 is formed so as to conform to the shape of the folded portion 30 of the resin liner 20, a large-diameter protruding portion 11c is formed continuously from the depressed portion 11b, and a mouthpiece cylindrical portion 11d having a constant diameter is formed to the rear of the protruding portion 11c. The diameter-reduced portion 30a of the folded portion 30 of the resin liner 20 is in close contact with a surface of the protruding portion 11c, and the cylindrical portion 30b is in close contact with a surface of the mouthpiece cylindrical portion 11d. Although not particularly shown, a seal member such as an O ring is interposed between the cylindrical portion 30b and the mouthpiece cylindrical portion 11d.

In addition, a metallic seal 90 is formed at a contact portion of an outside end surface of the mouthpiece 11 and a rear surface of a head part of the valve assembly 50 so that the outside end surface of the mouthpiece 11 and the rear surface of the head part of the valve assembly 50 come into contact with each other in an airtight manner (refer to FIG. 2). Therefore, in a state where the valve assembly 50 is fastened to the mouthpiece 11, the contact surface therebetween is sealed so that gas does not permeate between the mouthpiece 11 and the valve assembly 50. For example, in the case of the high-pressure tank 1 according to the present embodiment, the metallic seal 90 is formed at least an radially-outward portion than the tubular space 70, thereby creating a state where a gap between the tubular space 70 and the outside of the tank is sealed.

The valve assembly (in the present specification, also simply referred to as a valve) 50 controls supply and discharge of fuel gas between an outside gas supply line and the inside of the high-pressure tank 1. An O ring 60 as a seal member is interposed between the outer circumferential surface of the valve assembly 50 and the inner circumferential surface of the mouthpiece 11 (refer to FIG. 2).

In addition, a solenoid valve 62 and a feedthrough 63 are provided at an end of the valve assembly 50 near the tank main body (refer to FIG. 2). The solenoid valve 62 opens and closes in accordance with electrical signals and is controlled so as to supply a predetermined amount of fuel gas to the fuel cell system at a predetermined time. The feedthrough 63 is a device for feeding wiring 64 that is connected to the solenoid valve 62 into a high-pressure interior of the tank from the outside of the tank. The feedthrough 63 according to the present embodiment is installed in a depressed portion formed at an end of the valve assembly 50 in a state where a part of the wiring 64 is airtightly sealed. An O ring 61 as a seal member is interposed between the depressed portion and the feedthrough 63 (refer to FIG. 2).

The wiring 64 is routed using a wiring space 80 formed inside the valve assembly 50. The wiring space 80 is an elongated space formed along the axial direction of the tank so as to penetrate the inside of the valve assembly 50, and an end of the wiring space 80 is linked to the outside of the tank (refer to FIG. 2). At this end of the wiring space 80, a grommet 65 for protecting the wiring 64 is provided between an inner circumferential surface of the wiring space 80 and the wiring 64. The wiring space 80 having both ends sealed by the grommet 65 and the O ring 61 is a space in which any hydrogen gas having permeated the seal (specifically, the O ring 61) may accumulate.

In addition, the tubular space 70 constituted by an approximately tubular gap is formed between the mouthpiece 11 and the valve assembly 50 described above (refer to FIG. 2). Since one end of the tubular space 70 is sealed by the metallic seal 90 described above and another end of the tubular space 70 is sealed by the O ring 60, the tubular space 70 is a space in which any hydrogen gas permeating the seal (specifically, the O ring 60) may accumulate.

In the present embodiment, a communicating hole 51 that communicatively connects the wiring space 80 with the tubular space 70 described above is provided in the valve assembly 50 (refer to FIG. 2). Specifically, the communicating hole 51 is constituted by a narrow hole formed so as to link the outer circumferential surface of the valve assembly 50 to the wiring space 80. While a diameter of the communicating hole 51 is not particularly limited as long as the communicating hole 51 is capable of discharging gas accumulating in the spaces 70 and 80, since an excessively narrow communicating hole 51 may adversely affect processing, the diameter of the communicating hole 51 should be set as appropriate in consideration of various circumstances.

Furthermore, in the present embodiment, a gas venting hole 52 for discharging gas having permeated from inside the high-pressure tank 1 to the outside of the tank is provided only for the tubular space 70 (refer to FIG. 2). A GORE-TEX® seal 66 having both waterproofing and aeration properties is provided at an opening 52a of the gas venting hole 52 in order to avoid penetration (back penetration) of water or the like from the outside of the gas venting hole 52 (refer to FIG. 2).

As described above, with the high-pressure tank 1 configured such that spaces in which gas having permeated from the tank side may potentially accumulate (in the case of the present embodiment, the tubular space 70 formed between the mouthpiece 11 and the valve assembly 50 and the wiring space 80 formed in a vicinity of the center of the valve assembly 50) are bypassed to each other, for example, gas accumulating in the wiring space 80 can be discharged via the communicating hole 51 from another space (the tubular space 70) to the outside of the tank through the gas venting hole 52. Therefore, with the high-pressure tank 1 according to the present embodiment, a part of gas venting holes and GORE-TEX® seals which were conventionally required can be omitted. Specifically, a gas venting hole 152 and a GORE-TEX® seal 166 which were conventionally provided in correspondence with the wiring space 80 are omitted in the high-pressure tank 1 according to the present embodiment (refer to dashed-two dotted lines in FIG. 2).

Furthermore, in the present embodiment, the gas venting hole 52 described above is formed so as to extend from the tubular space 70 in a direction that intersects a contact surface between the mouthpiece 11 and the valve assembly 50 (refer to FIG. 2). In other words, the gas venting hole 52 is formed approximately perpendicular to the contact surface between the mouthpiece 11 and the valve assembly 50 on which the metallic seal 90 is formed (refer to FIG. 2). In such a case, plane contact between metals enables the sealed contact surface between the mouthpiece 11 and the valve assembly 50 to remain unharmed and gas accumulating in the spaces 70 and 80 to be discharged through the gas venting hole 52.

In addition, in the present embodiment, the communicating hole 51 described above is provided closer to the center of the tank than to the screw portion 53 of the valve assembly 50 (refer to FIG. 2). In the case of the present embodiment where the communicating hole 51 is provided so as to avoid the screw portion 53 as described above, the communicating hole 51 can be processed more easily than in a case where the communicating hole 51 is provided at the screw portion 53. Furthermore, in the present embodiment, the communicating hole 51 is arranged so as to extend linearly in a radial direction of the valve assembly 50 (refer to FIG. 2). In such a case, a length of the communicating hole 51 can be minimized (refer to FIG. 2).

As described above, in the present embodiment, in the high-pressure tank 1 having a configuration where internal gas is sealed using the O rings (seal members) 60 and 61 and which requires a plurality of gas venting holes 52 to discharge gas having permeated the O rings 60 and 61 to the outside of the tank and also requires GORE-TEX® seals 66 to avoid penetration of liquids such as water, a part of the gas venting holes (152) and GORE-TEX® seals 66 can be omitted by using the communicating hole 51. Generally, a space (the space 70) exists between the mouthpiece 11 and the valve assembly 50, and other spaces such as the wiring space 80 may also exist. Accordingly, as the numbers of gas venting holes 52 and GORE-TEX® seals 66 increase, costs of processing, assembly, and materials increase proportionally. In the present embodiment, by adopting a structure that enables a part of the gas venting holes 52 and GORE-TEX® seals 66 to be omitted, a reduction of such costs is achieved.

Moreover, while embodiments described above are examples of a preferable embodiment of the present invention, the present invention is not limited thereto and various modifications can be made without departing from the spirit of the present invention. For example, while a case where the gas venting hole 152 linked to the wiring space 80 and the GORE-TEX® seal 166 are omitted has been described for the respective embodiments above (refer to FIG. 2), it is obvious that, conversely, the gas venting hole 52 linked to the tubular space 70 and the GORE-TEX® seal 66 can be omitted. However, when the gas venting hole 152 becomes longer than the gas venting hole 52 as in the case of the high-pressure tank 1 illustrated in FIG. 2, it is more advantageous to omit the longer gas venting hole 152 from the perspective of performing ventilation more readily.

In addition, while the GORE-TEX® seal 66 is provided at the opening 52a of the gas venting hole 52 in the embodiments described above, this is merely a preferable example of a waterproof and moisture-permeable material having both waterproofing and aeration properties. Other members may alternatively be used as long as such members are capable of avoiding penetration of water into the tank from the outside of the gas venting hole 52.

Furthermore, while two spaces, namely, the tubular space 70 and the wiring space 80 have been illustrated as spaces in which gas having permeated from the tank side may potentially accumulate in the embodiments described above, the present invention is obviously also applicable to cases where three or more such spaces exist. In such a case, while two spaces among the three or more existing spaces may be communicatively connected by the communicating hole 51, communicatively connecting all of the spaces is more preferable from the perspective of omitting the gas venting holes 52 and the GORE-TEX® seals 66. An example of a case where there are three or more spaces is when other components such as a sensor are provided in addition to the aforementioned solenoid valve 62 and the number of spaces for wiring increases.

Moreover, while a case where the high-pressure tank 1 is a hydrogen high-pressure tank as a fuel supply source in a fuel cell system has been described in the above embodiments, this is also merely an example of a preferable embodiment of the present invention. To summarize, the present invention is applicable to a high-pressure tank having a valve structure in which high-pressure gas is sealed by an O ring or the like, the high-pressure tank comprising a gas venting hole that discharges gas having permeated the seal to the outside and prevents a liquid from penetrating from the outside, and two or more spaces in which gas may potentially accumulate.

The present invention can be suitably applied to various types of high-pressure tanks configured such that a valve is fastened to a mouthpiece, including a high-pressure tank filled with hydrogen gas or the like.

1. A high-pressure tank comprising a mouthpiece and a valve installed on the mouthpiece, wherein
the high-pressure tank is formed with:
a communicating hole that communicatively connects a wiring space in which gas having permeated from the tank side may potentially accumulate and which is formed in the valve in order to house wiring inside the valve, with a tubular space formed between the mouthpiece and the valve; and
a gas venting hole that connects either of the spaces to the outside of the tank.

2. The high-pressure tank according to claim 1, wherein the gas venting hole is formed so as to extend from the tubular space formed between the mouthpiece and the valve in a direction that intersects a contact surface between the mouthpiece and the valve.

3. (canceled)

4. The high-pressure tank according to claim 1, wherein the communicating hole is provided closer to a center of the tank than to a screw portion of the valve.

5. (canceled)

6. The high-pressure tank according to claim 1, wherein the communicating hole extends linearly in a radial direction of the valve.

7. The high-pressure tank according to claim 1, wherein a waterproof and moisture-permeable material having both waterproofing and aeration properties is provided at an opening of the gas venting hole to the outside of the tank.

8. The high-pressure tank according to claim 2, wherein the communicating hole extends linearly in a radial direction of the valve.

9. The high-pressure tank according to claim 4, wherein the communicating hole extends linearly in a radial direction of the valve.

10. The high-pressure tank according to claim 2, wherein a waterproof and moisture-permeable material having both waterproofing and aeration properties is provided at an opening of the gas venting hole to the outside of the tank.

11. The high-pressure tank according to claim 4, wherein a waterproof and moisture-permeable material having both waterproofing and aeration properties is provided at an opening of the gas venting hole to the outside of the tank.

12. The high-pressure tank according to claim 6, wherein a waterproof and moisture-permeable material having both waterproofing and aeration properties is provided at an opening of the gas venting hole to the outside of the tank.
